(19) United States
(12) Patent Application Publication
(10) Pub. No.: US 2011/0209075 A1
(43) Pub. Date: Aug. 25, 2011

(54) PAGE RESOURCE PROCESSING METHOD AND SYSTEM

(75) Inventor: YONG WAN, Beijing (CN)

(73) Assignee: BEIJING SOGOU TECHNOLOGY DEVELOPMENT CO., LTD., Beijing (CN)

(21) Appl. No.: 13/098,457

(22) Filed: Apr. 30, 2011

Related U.S. Application Data
(63) Continuation of application No. PCT/CN2009/074931, filed on Nov. 13, 2009.

(30) Foreign Application Priority Data
Nov. 14, 2008 (CN) 200810226380.5

(51) Int. Cl. G06F 3/01; G06F 15/16

(52) U.S. Cl. 715/760

(57) ABSTRACT

A method is disclosed for processing web page resources on a computer having a web browser. The method includes loading a web page through the web browser from a server, requesting from the server a specific resource related to the web page being loaded, and obtaining attribute information of the specific resource. The method also includes identifying the specific resource related to the web page based on the attribute information, determining a corresponding relationship between the specific resource and the web page, and displaying a prompt indicating the specific resource related to the web page based on the corresponding relationship between the specific resource and the web page.

### CROSS-REFERENCES TO RELATED APPLICATIONS

This application claims the priority of PCT patent application no. PCT/CN2009/074931, filed on Nov. 13, 2009, which claims the priority of Chinese patent application no. 200810226380.5, filed on Nov. 14, 2008, the entire contents of all of which are incorporated herein by reference.

### FIELD OF THE INVENTION

The present invention relates to the field of browser technology and, more particularly, relates to page resource processing methods and systems.

### BACKGROUND

With the development of multimedia technologies, people can view a rich variety of information resources on the Internet through browsers. These different types of resources bring a variety of visual or audio experience to the viewers.

In general, a web page can provide a large amount of information. However, web page-related resources may exist in many different forms, and some web page-related resources often cannot be fully explored and utilized. Thus, the utilization rate of the web page-related resources cannot be guaranteed, and the value of web page-related resources cannot be truly realized. For example, some audio resources are used as the web page background music, and the web page does not have a corresponding player. Thus, a user can only learn the presence of the resources by listening. That is, if the user does not open any audio device, the user cannot be aware of the existence of the audio resources in the web page, and the audio resources thus cannot be utilized.

The disclosed methods and systems are directed to solve one or more problems set forth above and other problems.

### BRIEF SUMMARY OF THE DISCLOSURE

One aspect of the present disclosure includes a method for processing web page resources on a computer having a web browser. The method includes loading a web page through the web browser from a server, requesting from the server a specific resource related to the web page being loaded, and obtaining attribute information of the specific resource. The method also includes identifying the specific resource related to the web page based on the attribute information, determining a corresponding relationship between the specific resource and the web page, and displaying a prompt indicating the specific resource related to the web page based on the corresponding relationship between the specific resource and the web page.

Another aspect of the present disclosure includes a computer-readable medium containing executable computer programs. When executed by a computer having a web browser, the executable computer programs perform a method for processing web page resources on the computer. The method includes loading a web page through the web browser from a server, requesting from the server a specific resource related to the web page being loaded, and obtaining attribute information of the specific resource. The method also includes identifying the specific resource related to the web page based on the attribute information, determining a corresponding relationship between the specific resource and the web page, and displaying a prompt indicating the specific resource related to the web page based on the corresponding relationship between the specific resource and the web page.

Other aspects of the present disclosure can be understood by those skilled in the art in light of the description, the claims, and the drawings of the present disclosure.

### BRIEF DESCRIPTION OF THE DRAWINGS

FIG. 1A illustrates an exemplary network environment incorporating certain aspects of the disclosed embodiments;

FIG. 1B illustrates a block diagram of an exemplary client computer consistent with the disclosed embodiments;

FIG. 2A illustrates an exemplary page resource processing system consistent with the disclosed embodiments;

FIG. 2B illustrates an exemplary page resource processing process consistent with the disclosed embodiments;

FIG. 3 illustrates a configuration of the page resource processing system consistent with the disclosed embodiments;

FIG. 4 illustrates another configuration of the page resource processing system consistent with the disclosed embodiments;

FIG. 5 illustrates another configuration of the page resource processing system consistent with the disclosed embodiments; and

FIG. 6 illustrates another configuration of the page resource processing system consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

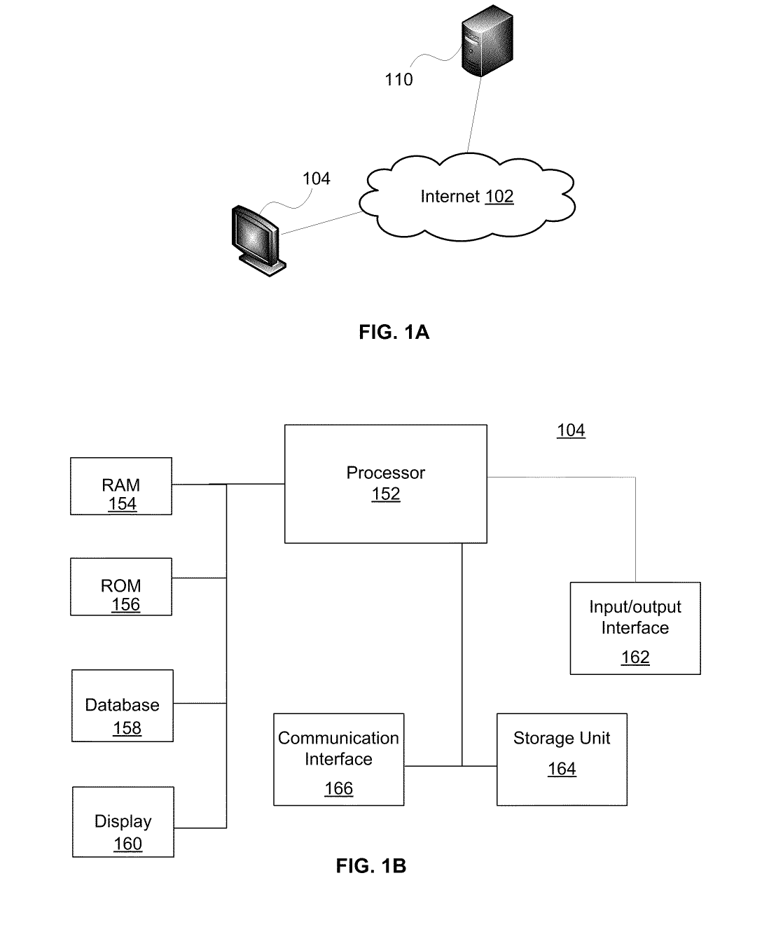

FIG. 1A illustrates an exemplary network environment incorporating certain aspects of the disclosed embodiments. As shown in FIG. 1A, network environment 100 may include the Internet 102, a client computer 104, and a server 110. Other components may be added without departing from the principles of the disclosed embodiments.

The Internet 102 may include any private and public computer networks interconnected using the standard transport control protocol/internet protocol (TCP/IP). Internet 102 may carry a large number of services over IP, such as the inter-linked hypertext documents of the World Wide Web (WWW) and hyper text transfer protocol (HTTP). Internet 102 may connect a large number of websites.

Server 110 may include any appropriate computer servers, software, and databases so as to provide various websites and/or web pages. Further, client computer 104 may include any appropriate types of computers operated by a user or users to access web-based or local web pages. For example, client computer 104 may include personal computer equipment and the like, or a mobile phone, mobile communications equipment, a personal digital assistant (PDA) and other electronic equipment and computing platforms and software programs. FIG. 1B shows a block diagram of an exemplary client computer 104.

As shown in FIG. 1B, client computer 104 may include a processor 152, a random access memory (RAM) unit 154, a read-only memory (ROM) unit 156, a database 158, a display 160, an input/output interface unit 162, a storage unit 164, and a communication interface 166. Other components may be added and certain devices may be removed without departing from the principles of the disclosed embodiments.

Processor 152 may include any appropriate type of graphic processing unit (GPU), general-purpose microprocessor, digital signal processor (DSP) or microcontroller, and application specific integrated circuit (ASIC), etc. Processor 152 may execute sequences of computer program instructions to perform various processes associated with client computer 104. The computer program instructions may be loaded into RAM 154 for execution by processor 152 from read-only memory 156.

Database 158 may include any appropriate commercial or customized database to be used by client computer 104, and may also include query tools and other management software for managing database 158. Display 160 may include any appropriate computer monitor, such as an LCD monitor. Further, input/output interface 162 may be provided for a user or users to input information into client computer 104 or for the user or users to receive information from client computer 104. For example, input/output interface 162 may include any appropriate input device, such as a remote control, a keyboard, a mouse, a microphone, a video camera or web-cam, an electronic tablet, voice communication devices, or any other optical or wireless input devices. Input/output interface 162 may include any appropriate output device, such as a speaker, or any other output devices.

Storage unit 164 may include any appropriate storage device to store information used by client computer 104, such as a hard disk, a flash disk, an optical disk, a CR-ROM drive, a DVD or other type of mass storage media, or a network storage. Further, communication interface 166 may provide communication connections such that client computer 104 may be accessed remotely and/or communicate with other systems through computer networks or other communication networks via various communication protocols, such as TCP/IP, hyper text transfer protocol (HTTP), etc.

Returning to FIG. 1A, during operation, client computer 104 may access various web pages from server 110 through Internet 102. A web page may contain one or more specific resources (or simply resources). A specific resource, as used herein, may refer to any media content associated with a web page. For example, a specific resource related to a web page may include any one or more of a video resource, an audio resource, an image resource, a text resource, and an animation resource (including GIF animations, flash animations, etc.). Any other or future types of contents or resources may also be included.

Further, a specific resource may be related to a web page in various ways. For example, specific resources related to a web page may include any specific resource contained in the web page (such as a picture, a text resource, a background music, etc., in the current web page itself); any specific resource in a sub-page of the current web page (for example, some pages on the Mop Mop main web page are sub-pages of the Mop Mop main web page); any specific resources in web pages related to the current web page, and any specific resource backend-transferred in the web page (for example, the audio, video and other resources played by a player embedded in the web page are backend transferred in the web page), and so on. Further, a web page related to the current web page may include a web page pointed to by a hyperlink in the current web page, or have a same theme as the current web page (for example, in the BBS system, due to a large number of threads, several web pages may have the same theme). Other relationship may also be included.

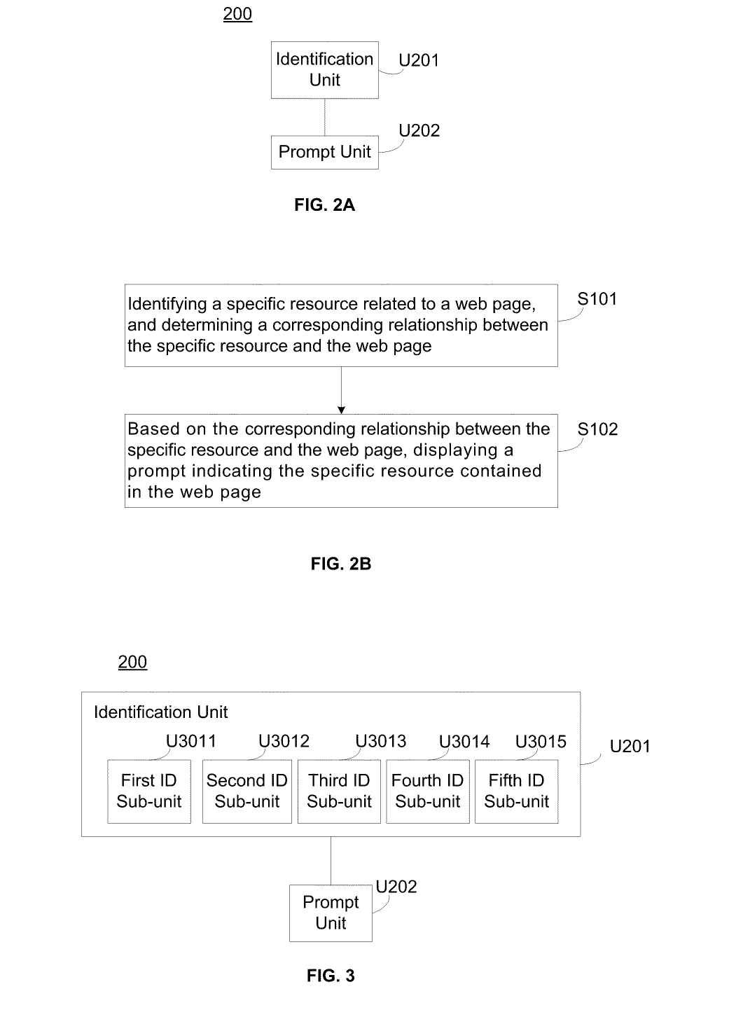

Client computer 104 may process the specific resources related to the web page to facilitate a user of client computer 104 to explore and utilize the specific resources. FIG. 2A illustrates an exemplary page resource processing system 200 consistent with the disclosed embodiments.

As shown in FIG. 2A, page resource processing system 200 may include an identification unit U201 and a prompt unit U202. Other components may also be included. Identification unit U201 may include any appropriate software and/or hardware module configured to identify a specific resource related to a web page and to determine the corresponding relationship between the specific resource and the web page. Prompt unit U202 may also include any appropriate software and/or hardware module configured to display a prompt indicating the specific resource related to the web page based on the corresponding relationship between the specific resource and the web page.

FIG. 2B illustrates an exemplary process performed by page resource processing system 200 (e.g., identification unit U201 and prompt unit U202). As shown in FIG. 2B, identification unit U201 may first identify a specific resource related to a web page and then may determine a corresponding relationship between the specific resource and the web page (S101). Further, prompt unit U202 may display a prompt indicating the specific resource contained in the web page based on the corresponding relationship between the specific resource and the web page (S102). Details of the exemplary process and exemplary page resource processing system 200 are described in following sections.

Specific resources may be published or posted on a web page in different ways, but in general the specific resources need to be downloaded by a browser from the server 110 before the specific resources can be posted on the web page. For example, when a browser loads a web page, the browser may send a request to server 110 for loading a specific resource contained in the web page. The request may include certain attribute information about relevant entities (e.g., the web page and the specific resource) such as uniform resource location information. The uniform resource location information may be used by server 110 to find the corresponding web page, specific resource, and other entities. In practice, the uniform resource location information may include a uniform resource identifier (URI), which may be a uniform resource locator (URL) or a uniform resource name (URN). For simplicity purposes, the URL is used as the uniform resource location information for illustrative purposes. Any other appropriate types of resource location information may be used.

That is, when the web page is being loaded, a request message for downloading the resources needs to be sent to the server 110. The request message may include uniform resource locator information to be used to identify the specific resources. Thus, identification unit U201 may intercept the request message sent to server 110 to obtain various uniform resource locator information.

For example, when the browser is downloading a picture resource, a text resource, or a background audio resource related to the web page, a request message for downloading the resource is sent to the server by the browser. The request message includes the URL of the resource and the URL of the web page containing the resource. Therefore, by directly intercepting the request message sent to the server by the browser for downloading the specific resource related to the web page, identification unit U201 may obtain the URL of the specific resource and the URL of the web page.

After obtaining the URL, identification unit U201 may analyze or check a suffix of the URL of the specific resource in the request message. Because the suffix can usually indicate the type of the specific resource associated with the URL, identification unit U201 may analyze the suffix of the URL to identify the type of the specific resource related to the web page. For example, when identification unit U201 finds the suffix of the URL is jpg; identification unit U201 may identify the specific resource as an image resource. Similarly, identification unit U201 may identify the video resource, audio resource, image resource, animation resource, and text resource based on the suffices of the corresponding URLs. Identification unit U201 may also identify the name, download address, and other attributes of the specific resource based on the obtained URL.

Further, identification unit U201 may use the URL of the web page sending the request message in the request message to determine the corresponding relationship between the specific resource and the web page, e.g., to determine which web page the specific resource is located in.

However, certain specific resources, such as an audio resource or a video resource played by a player embedded in the web page, unlike the picture resource or text resource in the web page, the browser itself cannot play such resource. The request message for downloading such resource is sent by the player embedded in the web page to server 110. That is, first the browser downloads the player from the server 110 based on the player's URL, and the player then downloads the audio or video resource based on the URL of the audio or video resource.

Thus, under this circumstance, two request messages may be sent to server 110. The first request message is sent from the browser to server 110 for downloading the player, and the second request message is sent from the player to server 110 for downloading the specific resource. The first request message includes the URL of the player and the URL of the web page, and the second request message includes the URL of the resource and the URL of the player.

Therefore, identification unit U201 may first intercept the first request message for downloading the player sent to the server 110 by the browser to obtain URL information in the first request message, such as the URL of the web page and the URL of the player to be downloaded. Identification unit U201 may also use the URL of the web page to determine a corresponding relationship between the player and the web page.

Further, identification unit U201 may intercept the second request message for downloading the specific resource sent to the server 110 by the player to obtain URL information in the second request message, such as the URL of the player and the URL of the specific resource. Identification unit U201 may also analyze the suffix of the URL of the specific resource in the second request message to identify the specific resource. Further, identification unit U201 may determine a corresponding relationship between the player and the specific resource based on the URL of the player.

Moreover, based on the corresponding relationship between the web page and the player, and the corresponding relationship between the player and the specific resource, identification unit U201 may determine the corresponding relationship between the specific resource and the web page, e.g., which web page the specific resource is located in.

However, under certain other circumstances, the browser or embedded player may send server 110 a request including an arbitrary URL suffix for downloading certain resources. Such arbitrary URL suffix normally does not impact operation of the browser or other software on client computer 104. For example, an image resource normally has a URL with the suffix of ‘jpg,’ but the browser may send out the resource request including the URL of the image resource with a suffix of ‘123,’ and the browser can still download the image resource from server 110 and display the downloaded image resource. However, identification unit U201 may be unable to accurately identify the type of the image resource based on the URL suffix of ‘123’ or other arbitrary suffix.

Thus, identification unit U201 may also intercept a response from server 110 in reply to the request sent by the browser or the embedded player. The response message may also contain attribute information of the web page, the embedded player, and/or the specific resource. For example, the response message may include a response header and data portion (i.e., a binary data stream of the resource file requested by the browser). By analyzing certain parts of the data portion or data contents, identification unit U201 may be able to identify the type of resource file sent by server 110. For instance, a ‘gif’ image may be determined if the first six bytes of the data contents are ‘GIF89a,’ and a ‘Flv’ format is determined if the first three bytes of the data contents are ‘FLV,’ etc. Therefore, the data portion of the server response message may provide accurate information to identify the type of the requested resource. Other file formats may also be identified similarly.

Therefore, during operation, identification unit U201 may first intercept a request message sent to the server 110 by the browser. If identification unit U201 cannot identify the type of the specific resource, or if identification unit U201 determines to intercept the response message from server 110, identification unit U201 may further intercept the response message returned by the server 110. For example, identification unit U201 may be configured to identify the type of the resource using the request message to server 110 from the browser first, and using the response message from server 110 when the request fails to provide the type information.

However, according to the HTTP protocol, although the request message includes the URL of the requesting web page, the server 110 returns the response message based on the number of each request message received. Thus, the response message returned from the server 110 may no longer include the URL of the requesting web page, and the corresponding relationship between the web page and the specific resource cannot be obtained directly from the response message. Thus, identification unit U201 may find a request message corresponding to the intercepted response message based on the number. Further, based on the URL of the requesting web page in the corresponding request message, identification unit U201 can determine the corresponding relationship between the web page and the specific resource.

That is, identification unit U201 may use the data portion of the response message to identify the specific resource related to the web page, then find the request message corresponding to the response message to determine which web page sent out the request message (as the request message includes the URL of the requesting web page), and finally determine the corresponding relationship between the specific resource and the web page.

In addition, for those specific resources that need to be played by a player embedded in the web page, such as an audio resource or a video resource played by an embedded player, identification unit U201 may perform additional processing. For example, identification unit U201 may first intercept the first request message to request downloading the player sent to the server 110 by the browser. Because the first request message includes the URL of the web page and the URL of the player to be downloaded, identification unit U201 may determine the corresponding relationship between the player and the web page based on the URL of the web page.

After the player is downloaded, identification unit U201 may intercept the second request message to request downloading the specific resource sent to the server 110 by the player, and also the response message returned to the player from the server 110. Further, identification unit U201 may use the data portion of the response message returned to the player to identify the specific resource (including the resource type). Identification unit U201 may also find the second request message corresponding to the response message based on the request number or other identification information. Because the second request message includes the URL of the player and the URL of the specific resource to be downloaded, the corresponding relationship between the player and the specific resource can be determined based on the URL of the player in the second request message. Finally, based on the corresponding relationship between the web page and the player, and the corresponding relationship between the player and the specific resource, identification unit U201 may determine the corresponding relationship between the specific resource and the web page.

In addition to identifying the specific resource related to the web page and determining the corresponding relationship between the web page and the specific resource through intercepting information when loading the web page, as above described, other methods may also be used. For example, identification unit U201 may identify the specific resource related to the web page and determine the corresponding relationship between the web page and the specific resource through analyzing the front page elements of the web page.

For example, for a picture in the web page, identification unit U201 may analyze the page elements of the web page. If the page elements include a <html:img> tag, identification unit U201 may determine that the web page contains a picture element. Further, based on the coordinates or other attribute information of the element in the web page, identification unit U201 may determine the corresponding relationship between the picture and the web page containing the picture.

Further, identification unit U201 is coupled to prompt unit U202. After the specific resource related to the web page is identified and the corresponding relationship between the specific resource and the web page is determined, prompt unit U202 may display a prompt indicating such specific resource contained in the web page.

More particularly, prompt unit U202 may display the prompt indicating the specific resource contained in the current web page in the same window in which the current web page having the specific resource is located. The prompt may be a prompt icon or any other type of indicator. Prompt unit U202 may display the prompt at various locations of the window of the current web page, such as the browser's address bar, tab bar, tool bar, side bar, and floating toolbar page near the location of the specific resource on the web page.

If the web page containing the specific resource is currently being displayed, prompt unit U202 may display the prompt at any one or more of the above-mentioned locations. However, if the web page containing the specific resource is minimized or another window is currently being displayed, the user can only see the tab bar corresponding to the web page containing the specific resource, prompt unit U202 may then display the prompt indicating the specific resource in the web page on the tab bar. Further, in order to prompt on a floating toolbar near the location of the resource, prompt unit U202 may analyze the front page elements to obtain the coordinates of the location of the specific resource. When the user moves the mouse over the location of the specific resource or clicks on the location, the corresponding floating toolbar can be displayed based on the corresponding coordinates.

Further, prompt unit U202 may display the prompt icon to only indicate the type of specific resource. Prompt unit U202 may also display any appropriate information, such as name, size, and other information of the specific resource. For example, prompt unit U202 may display the name of the prompted resource, and the title and lyrics of the background music, etc. Further, in order to facilitate downloading by the user, a download address of the specific resource can also be provided to the user by prompt unit U202, so that the user can easily download the specific resource. In operation, prompt unit U202 may obtain the resource name and download address from the request message for downloading the resource sent to the server 110, and may obtain the lyrics of the background music by searching the Internet using certain searching tools.

When more than one contents are included in the prompt, such as the resource name, lyrics, and download address, etc., prompt unit U202 may display the resource prompt with a drop-down list to prompt the multiple contents. Thus, the user can easily know which specific resource the web page has and, further, if the user is interested, the user can click on or move the mouse over the prompt icon, and then the prompt icon can use the drop-down list to show the user any one or more of resource name, lyrics, and download address, etc. Of course, the contents of the prompt icon can be directly seen from the prompt icon, or can be seen only when clicking on the prompt icon or moving the mouse over the prompt icon, such as the name, the download address, and other information. When the user clicks on the prompt icon or moves the mouse over the prompt, the contents are displayed to the user. In other words, not all contents of the prompt are displayed on the web page.

In addition, if a web page has two or more specific resources of the same type, such as multiple videos, prompt unit U202 may display only one prompt icon on the current web page, and the respective information of the multiple videos can be displayed on the drop-down list of the video prompt icon. However, if a web page contains two or more different types of specific resources, such as a video resource and an audio resource, prompt unit U202 may display two prompt icons on the current web page, one is the audio prompt icon, and the other one is the video prompt icon.

Also, in addition to displaying a prompt icon with respect to each web page, prompt unit U202 may integrate together information on the specific resources contained in various web pages in a unified prompt, and may display the unified prompt icon instead of with various prompts. For example, when the user opens more than two web pages and specific resources are identified in multiple web pages, prompt unit U202 may provide a single unified prompt icon on a toolbar of the browsing tool (e.g., the browser). That is, not every web page provides a prompt icon at a specific location. When the user moves the mouse over or clicks on the unified prompt icon, the unified prompt icon can use a drop-down list to show information on the specific resources in each web page (e.g., resource name, lyrics, download address, and other relevant information). Further, when the drop-down list is used to prompt the user, the title and the URL of the web page and other information can be used to uniquely identify the web page, and the type and name, etc., of the specific resources in each web page may be displayed at the same time.

When there are two or more specific resources in a web page, prompt unit U202 may also integrate the information together into a unified prompt, and display the single unified prompt icon. For example, if five video resources are identified in a web page currently opened by the user, prompt unit U202 may display a prompt icon showing five videos in the web page at a certain location of the web page or on a toolbar of the browser in the form of a drop-down list.

As previously explained, the specific resource(s) may include various types and may be related to the web page in various ways. Page resource processing system 200 may be configured in various ways accordingly. FIG. 3 illustrates an exemplary configuration of page resource processing system 200.

As shown in FIG. 3, page resource processing system 200 may include identification unit U201 and prompt unit U202. Identification unit U201 may further include a first identification sub-unit U3011, a second identification sub-unit U3011, a third identification sub-unit U3011, a fourth identification sub-unit U3011, and a fifth identification sub-unit U3011. Certain components may be omitted and certain other components may be added.

First identification sub-unit U3011 may include any appropriate software and/or hardware modules used to identify one or more specific resources in the current web page and to determine a corresponding relationship between the specific resources and the current web page. First identification sub-unit U3011 may operate in ways similar to those of identification unit U201 in FIG. 2A as described in above sections, the description of first identification sub-unit U3011 is thus omitted.

Second identification sub-unit U3012 may include any appropriate software and/or hardware modules used to identify the specific resources in the sub-page of the current web page and to determine the corresponding relationship between the specific resources and the current web page. For example, second identification sub-unit U3012 may perform similar operations to those of first identification sub-unit U3011 when the sub-page is being loaded.

Third identification sub-unit U3013 may include any appropriate software and/or hardware modules used to identify the specific resources backend-transferred in the current web page, mainly referring to the audio or video resources played by a player embedded in the current web page, and to determine the corresponding relationship between the specific resource and the current web page.

Further, fourth identification sub-unit U3014 may include any appropriate software and/or hardware modules used to identify specific resources contained in a web page pointed to by a hyperlink in the current web page and to determine the corresponding relationship between the specific resource and the current web page. That is, fourth identification sub-unit U3014 may identify the specific resources contained in another web page related to the current web page (e.g., being pointed by a hyperlink). For example, fourth identification sub-unit U3014 may download or pre-load the web page pointed to by the hyperlink to perform the identification and determination when the pointed web page is being loaded, according to the various operations explained above.

Fifth identification sub-unit U3015 may include any appropriate software and/or hardware modules used to identify specific resources contained in other web pages having the same theme as the current web page. Similar to fourth identification sub-unit U3013, fifth identification sub-unit U3015 may also download or pre-load the web pages having the same theme, and to perform the identification and determination when these web pages are being loaded, according to the various operations explained above.

That is, the various identification sub-units may intercept the information during loading the relevant web pages or analyze the front page elements of the relevant web pages so as to identify specific resources related to the current web page, and to determine a corresponding relationship between the specific resources and the web page. For sub-pages of the web page, web pages pointed by the hyperlinks, and web pages with the same theme, these pages may be pre-loaded to identify the specific resources in these related web pages.

Further, for the specific resources in a web page pointed to by the hyperlink at the current web page, prompt unit U202 may display the prompt in the current web page containing the hyperlink, such as prompting “This link contains a video resource,” etc. For the specific resources in the web pages having the same theme as the current web page, prompts such as “Next page contains pictures,” may be displayed by prompt unit U202 at the current web page, or prompts may be displayed directly on the picture attachment such as “Previous” and “Next,” etc. Or image positioning techniques may be used together with the prompting such that, when a user clicks on the “Next”, the location of the next picture can be directly jumped to (including the situation when the next picture is on the next page.)

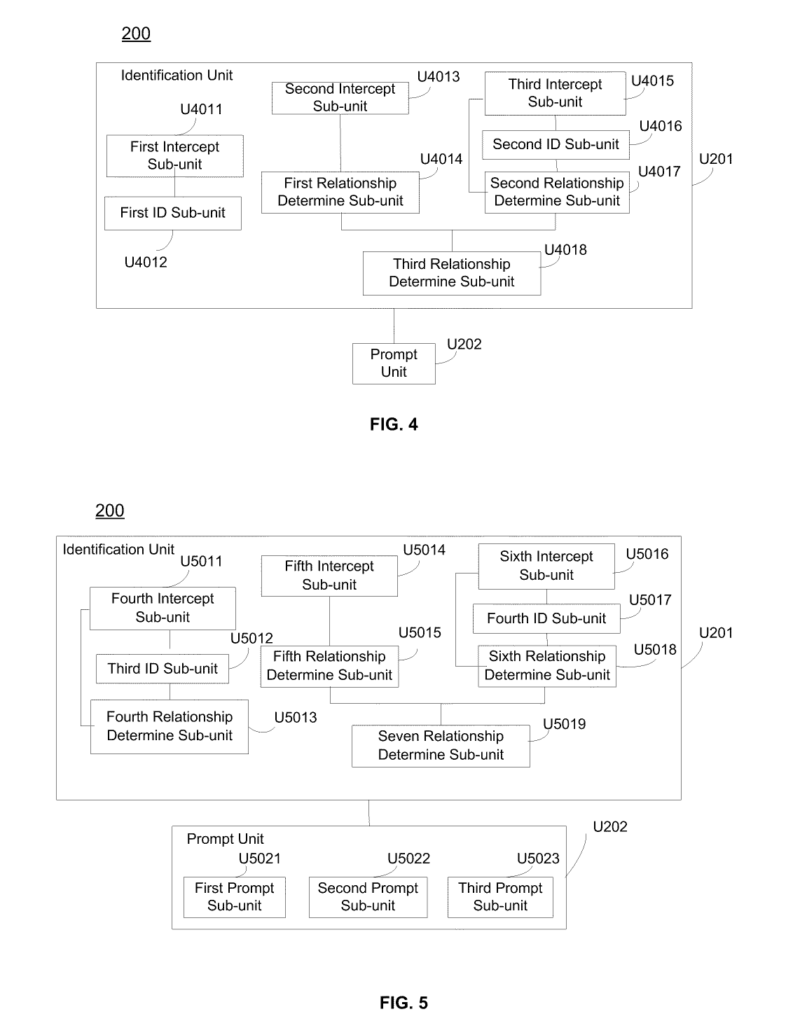

FIG. 4 illustrates another configuration of page resource processing system 200 with details. As shown in FIG. 4, page resource processing system 200 may include identification unit U201 and a prompt unit U202. Identification U201 may further include a first intercept sub-unit U4011 coupled with a first identification sub-unit U4012.

During operation, first intercept sub-unit U4011 may intercept a request message for downloading a specific resource related to the web page sent to the server 110 from the browser, and the request message includes the URL of the web page and the URL of the specific resource. For example, first intercept sub-unit U4011 may use functions of the operating system of client computer 104 to copy or inspect part or all of the contents of the request message sent to server 110. Further, first identification sub-unit U4012 may, based on the URL of the specific resource, identify the specific resource related to the web page, and to determine the corresponding relationship between the specific resource and the web page based on the URL of the web page.

Identification U201 may also include a second intercept sub-unit U4013 coupled with a first relationship determine sub-unit U4014, and a third intercept sub-unit U4015 coupled with a second identification sub-unit U4016 and a second relationship determine sub-unit U4017.

During operation, when the specific resource related to the web page needs to be played by a player embedded in the web page, second intercept sub-unit U4013 may intercept a first request message for downloading the player sent to the server 110 from the browser, and the first request message includes the URL of the web page and the URL of the player. Further, first relationship determine sub-unit U4014 may determine the corresponding relationship between the web page and the player based on the URL of the web page in the first request message.

Further, after the player is downloaded, third intercept sub-unit U4015 may intercept a second request message for downloading the specific resource sent to the server 110 from the player, and the second request message includes the URL of the specific resource and the URL of the player. Second identification sub-unit U4016 may thus be used to identify the specific resource based on the URL of the specific resource in the second request message. In addition, second relationship determine sub-unit U4017 may determine the corresponding relationship between the player and the specific resource based on the URL of the player in the second request message.

Identification unit U201 may also include a third relationship determine sub-unit U4018. Third relationship determine sub-unit U4018 may determine the corresponding relationship between the specific resource and the web page based on the corresponding relationship between the web page and the player and the corresponding relationship between the player and the specific resource. Other components and/or methods may also be used.

FIG. 5 illustrates yet another configuration of page resource processing system 200 with details. As shown in FIG. 5, page resource processing system 200 may include identification unit U201 and prompt unit U202. Identification U201 may further include a fourth intercept sub-unit U5011 coupled with a third identification sub-unit U5012 and a fourth relationship determine sub-unit U5013.

During operation, fourth intercept sub-unit U5011 may intercept a request message for downloading the specific resource related to the web page sent to the server 110 from the browser and the response message returned from the server 110. The request message includes the URL of the web page and the URL of the specific resource. Further, third identification sub-unit U5012 may identify the specific resource related to the web page based on the data portion of the response message. Fourth relationship determine sub-unit U5013 may determine a request message corresponding to the response message, and determine the corresponding relationship between the specific resource and the web page based on the URL of the web page in the request message.

Identification U201 may also include a fifth intercept sub-unit U5014 coupled with a fifth relationship determine sub-unit U5015, and a sixth intercept sub-unit U5016 coupled with a fourth identification sub-unit U5017 and a sixth relationship determine sub-unit U5018.

During operation, when the specific resource related to the web page needs to be played by a player embedded in the web page, fifth intercept sub-unit U5014 may intercept a third request message for downloading the player sent to the server 110 from the browser, and the third request message includes the URL of the web page and the URL of the player.

Further, fifth relationship determine sub-unit U5015 may determine the corresponding relationship between the web page and the player based on the URL of the web page in the third request message. After the player is downloaded, sixth intercept sub-unit U5016 may intercept a fourth request message for downloading the specific resource sent to the server 110 from the player and the response message returned by the server 110. The fourth request message includes the URL of the specific resource and the URL of the player.

Further, fourth identification sub-unit U5017 may identify the specific resource based on the data portion of the response message. Sixth relationship determine sub-unit U5018 may determine a request message corresponding to the response message, and determine the corresponding relationship between the specific resource and the player based on the URL of the player in the fourth request message;

Identification U201 may also include a seventh relationship determine sub-unit U5019. Seventh relationship determine sub-unit U5019 may determine the corresponding relationship between the specific resource and the web page based on the corresponding relationship between the web page and the player and the corresponding relationship between the player and the specific resource.

As previously explained, the specific resource that does not need to be played by a player embedded in the web page can include any one or more of image or picture, text, flash animation and web-page background music; and the specific resource that needs to be played by a player embedded in the web page can include video and/or audio resources capable of being played in a player embedded in the web page.

After the specific resource related to the web page is identified and the corresponding relationship between the specific resource and the web page is determined, prompt unit U202 can display a prompt indicating the specific resource contained in the web page on an address bar, tab bar, toolbar, and sidebar of a browsing tool (e.g., a browser) or on an area where the specific resource is located.

As previously explained, different prompting may be performed by prompt unit U202, and prompt unit U202 may also include certain sub-units to process different web pages and/or specific resources. For example, as shown in FIG. 5, prompt unit U202 may include a first prompt sub-unit U5021, a second prompt sub-unit U5022, and a third prompt sub-unit U5023. Other sub-units may also be included.

First prompt sub-unit U5021 may display the prompt indicating the specific resource contained in the current web page in a window of the current web page having the specific resource.

Further, when at least two web pages containing identified specific resources, second prompt sub-unit U5022 may integrate the information together into a unified prompt and display a unified prompt indicating the specific resources contained in each of the at least two web pages. When at least two specific resources are identified in the web page, third prompt sub-unit U4023 may display a unified prompt indicating the at least two specific resources contained in the web page.

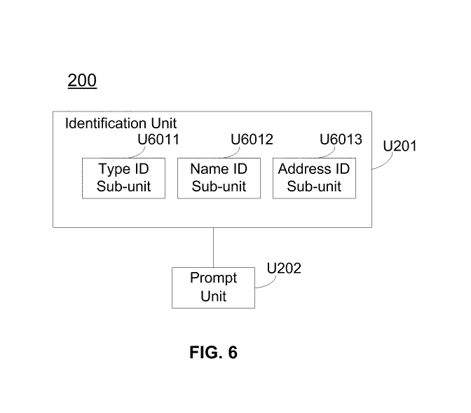

FIG. 6 illustrates another configuration of page resource processing system 200 consistent with the disclosed embodiments. As shown in FIG. 6, page resource processing system 200 may include identification unit U201 and prompt unit U202. Identification unit U201 may further include a type identification sub-unit U6011, a name identification sub-unit U6012, and an address identification sub-unit U6013.

During operation, type identification sub-unit U6011 may identify a type of the specific resource. After type identification sub-unit U6011 identifies the type of the specific resource, prompt unit U202 displays the prompt indicating the specific resource contained in the current web page, and the content of the prompt includes an indicator of the type of the specific resource.

Further, name identification sub-unit U6012 may identify a name of the specific resource. After name identification sub-unit U6012 identifies the name of the specific resource, prompt unit U202 displays the prompt indicating the specific resource contained in the current web page, and the content of the prompt includes an indicator of the name of the specific resource.

Further, address identification sub-unit U6013 may identify a download address of the specific resource. After address identification sub-unit U6013 identifies the download address of the specific resource, prompt unit U202 displays the prompt indicating the specific resource contained in the current web page, and the content of the prompt includes an indicator of the download address of the specific resource.

The disclosed systems and methods may provide many advantageous browser and other software applications in a variety of network or client environments, such as in personal computer equipment and the like, mobile phones, mobile communication devices, personal digital assistants (PDAs) and other electronic equipment. For example, by identifying a specific resource related to a web page and determining a corresponding relationship between the identified specific resource and the web page; and displaying a prompt indicating the specific resource contained in the web page based on the corresponding relationship between the specific resource and the web page, the disclosed systems and methods may be able to prompt the specific resource provided by the web page to a user in an intuitive way, thus enabling the user to clearly find a variety of resources related to the web page to facilitate the resources related to the web page to be fully explored and utilized. In addition, because the prompt is given based on the corresponding relationship between the specific resource and the web page, a user can clearly tell what specific resources are on which web page, and the given prompt will not be mistaken due to switching of current web page. Further, the prompt can be given on an address bar, tab bar, toolbar, and floating toolbar near the location of the specific resource, and the user can always get the appropriate prompting message. By prompting on the floating toolbar in the vicinity of the location of specific resources, the prompting message can appear more straightforward to the user. Other applications and advantages are obvious to those skilled in the art.

What is claimed is:

1. A method for processing web page resources on a computer having a web browser, comprising:
loading a web page through the web browser from a server;
requesting from the server a specific resource related to the web page being loaded;
obtaining attribute information of the specific resource;
identifying the specific resource related to the web page based on the attribute information;
determining a corresponding relationship between the specific resource and the web page; and
displaying a prompt indicating the specific resource related to the web page based on the corresponding relationship between the specific resource and the web page.

2. The method according to claim 1, wherein the specific resource is related to the web page by at least one of:
being contained in the web page;
being contained in a sub-page of the web page;
being backend-transferred in the web page;
being contained in another web page pointed by a hyperlink in the web page; and
being contained in a web page having a same theme as the web page.

3. The method according to claim 1, wherein the specific resource includes one or more of a video resource, an audio resource, an image resource, a text resource, and an animation resource.

4. The method according to claim 1, wherein obtaining attribute information includes:
intercepting a request message for downloading the specific resource sent to the server from the browser, the request message including uniform resource locator information of the specific resource and uniform resource locator information of the web page.

5. The method according to claim 4, wherein identifying the specific resource includes:
identifying the specific resource related to the web page based on the uniform resource locator information of the specific resource in the request message.

6. The method according to claim 5, wherein identifying the specific resource further include:
analyzing the uniform resource locator information of the specific resource;
obtaining a suffix of the uniform resource locator information of the specific resource; and
identifying the specific resource related to the web page based on the obtained suffix.

7. The method according to claim 5, wherein determining the corresponding relationship includes:
determining the corresponding relationship between the specific resource and the web page based on the uniform resource locator information of the web page in the request message.

8. The method according to claim 1, wherein the specific resource needs to be played by a player embedded in the web page, and obtaining attribute information includes:
intercepting a first request message for downloading the player sent to the server from the browser, the first request message including uniform resource locator information of the player and uniform resource locator information of the web page; and
intercepting a second request message for downloading the specific resource sent to the server from the player, the second request including uniform resource locator information of the specific resource and uniform resource locator information of the player.

9. The method according to claim 8, wherein identifying the specific resource includes:
identifying the specific resource related to the web page based on the uniform resource locator information of the specific resource in the second request message.

10. The method according to claim 9, wherein determining the corresponding relationship includes:
determining a corresponding relationship between the player and the web page based on the uniform resource locator information of the web page in the first request message;
determining a corresponding relationship between the specific resource and the player based on the uniform resource locator information of the player in the second request message; and
determining the corresponding relationship between the specific resource and the web page based on the corresponding relationship between the player and the web page and the corresponding relationship between the specific resource and the player.

11. The method according to claim 1, wherein obtaining attribute information includes:
intercepting a request message for downloading the specific resource sent to the server from the browser, the request message including uniform resource locator information of the specific resource and uniform resource locator information of the web page; and
intercepting a response message from the server in reply to the request message, the response message including a data portion.

12. The method according to claim 11, wherein identifying the specific resource includes:
identifying the specific resource related to the web page based on the data portion in the response message.

13. The method according to claim 12, wherein determining the corresponding relationship includes:
determining the request message corresponding to the response message; and
determining the corresponding relationship between the specific resource and the web page based on the uniform resource locator information of the web page in the request message.

14. The method according to claim 1, wherein the specific resource needs to be played by a player embedded in the web page, and obtaining attribute information includes:
intercepting a first request message for downloading the player sent to the server from the browser, the first request message including uniform resource locator information of the player and uniform resource locator information of the web page;
intercepting a second request message for downloading the specific resource sent to the server from the player, the second request including uniform resource locator information of the specific resource and uniform resource locator information of the player; and
intercepting a response message from the server in reply to the second request message, the response message including a data portion.

15. The method according to claim 14, wherein identifying the specific resource includes:
identifying the specific resource related to the web page based on the data portion in the response message.

16. The method according to claim 15, wherein determining the corresponding relationship includes:
determining the second request message corresponding to the response message;
determining a corresponding relationship between the player and the web page based on the uniform resource locator information of the web page in the first request message;
determining a corresponding relationship between the specific resource and the player based on the uniform resource locator information of the player in the second request message; and
determining the corresponding relationship between the specific resource and the web page based on the corresponding relationship between the player and the web page and the corresponding relationship between the specific resource and the player.

17. The method according to claim 1, wherein displaying the prompt includes:
displaying the prompt indicating the specific resource related to the web page on one or more of an address bar, a tab bar, a toolbar, and a sidebar of the browser and an area where the specific resource is located.

18. The method according to claim 1, wherein displaying the prompt includes:
displaying the prompt indicating the specific resource related to the current web page in a window of the web page containing the specific resource;
when at least two web pages containing identified specific resources, displaying a unified prompt indicating the specific resources contained in each of the at least two web pages; and
when at least two specific resources are identified in the web page, displaying a unified prompt indicating the at least two specific resources contained in the web page.

19. The method according to claim 1, wherein
identifying the specific resource includes identifying a type of the specific resource; and
a content of the prompt includes the type of the specific resource.

20. The method according to claim 1, wherein:
identifying the specific resource includes identifying a name of the specific resource; and
a content of the prompt includes the name of the specific resource.

21. The method according to claim 1, wherein:
identifying the specific resource includes identifying a download address of the specific resource; and
a content of the prompt includes the download address of the specific resource.

22. A computer-readable medium containing executable computer programs, when executed by a computer having a web browser, performing a method for processing web page resources on the computer, the method comprising:
loading a web page through the web browser from a server;
requesting from the server a specific resource related to the web page being loaded;
obtaining attribute information of the specific resource;
identifying the specific resource related to the web page based on the attribute information;
determining a corresponding relationship between the specific resource and the web page; and
displaying a prompt indicating the specific resource related to the web page based on the corresponding relationship between the specific resource and the web page.

23. The computer-readable medium according to claim 22, wherein the specific resource is related to the web page by at least one of:
being contained in the web page;
being contained in a sub-page of the web page;
being backend-transferred in the web page;
being contained in another web page pointed by a hyperlink in the web page; and
being contained in a web page having a same theme as the web page.

24. The computer-readable medium according to claim 22, wherein the specific resource includes one or more of a video resource, an audio resource, an image resource, a text resource, and an animation resource.

25. The computer-readable medium according to claim 22, wherein obtaining attribute information includes:
intercepting a request message for downloading the specific resource sent to the server from the browser, the request message including uniform resource locator information of the specific resource and uniform resource locator information of the web page.

26. The computer-readable medium according to claim 25, wherein identifying the specific resource includes:
identifying the specific resource related to the web page based on the uniform resource locator information of the specific resource in the request message.

27. The computer-readable medium according to claim 26, wherein identifying the specific resource further include:
analyzing the uniform resource locator information of the specific resource;
obtaining a suffix of the uniform resource locator information of the specific resource; and
identifying the specific resource related to the web page based on the obtained suffix.

28. The computer-readable medium according to claim 26, wherein determining the corresponding relationship includes:
determining the corresponding relationship between the specific resource and the web page based on the uniform resource locator information of the web page in the request message.

29. The computer-readable medium according to claim 22, wherein the specific resource needs to be played by a player embedded in the web page, and obtaining attribute information includes:
intercepting a first request message for downloading the player sent to the server from the browser, the first request message including uniform resource locator information of the player and uniform resource locator information of the web page; and
intercepting a second request message for downloading the specific resource sent to the server from the player, the second request including uniform resource locator information of the specific resource and uniform resource locator information of the player.

30. The computer-readable medium according to claim 29, wherein identifying the specific resource includes:
identifying the specific resource related to the web page based on the uniform resource locator information of the specific resource in the second request message.

31. The computer-readable medium according to claim 30, wherein determining the corresponding relationship includes:
determining a corresponding relationship between the player and the web page based on the uniform resource locator information of the web page in the first request message;
determining a corresponding relationship between the specific resource and the player based on the uniform resource locator information of the player in the second request message; and
determining the corresponding relationship between the specific resource and the web page based on the corresponding relationship between the player and the web page and the corresponding relationship between the specific resource and the player.

32. The computer-readable medium according to claim 22, wherein obtaining attribute information includes:
intercepting a request message for downloading the specific resource sent to the server from the browser, the request message including uniform resource locator information of the specific resource and uniform resource locator information of the web page; and
intercepting a response message from the server in reply to the request message, the response message including a data portion.

33. The computer-readable medium according to claim 32, wherein identifying the specific resource includes:
identifying the specific resource related to the web page based on the data portion in the response message.

34. The computer-readable medium according to claim 33, wherein determining the corresponding relationship includes:
determining the request message corresponding to the response message; and
determining the corresponding relationship between the specific resource and the web page based on the uniform resource locator information of the web page in the request message.

35. The computer-readable medium according to claim 22, wherein the specific resource needs to be played by a player embedded in the web page, and obtaining attribute information includes:
intercepting a first request message for downloading the player sent to the server from the browser, the first request message including uniform resource locator information of the player and uniform resource locator information of the web page;
intercepting a second request message for downloading the specific resource sent to the server from the player, the second request including uniform resource locator information of the specific resource and uniform resource locator information of the player; and
intercepting a response message from the server in reply to the second request message, the response message including a data portion.

36. The computer-readable medium according to claim 35, wherein identifying the specific resource includes:
identifying the specific resource related to the web page based on the data portion in the response message.

37. The computer-readable medium according to claim 36, wherein determining the corresponding relationship includes:
determining the second request message corresponding to the response message;
determining a corresponding relationship between the player and the web page based on the uniform resource locator information of the web page in the first request message;
determining a corresponding relationship between the specific resource and the player based on the uniform resource locator information of the player in the second request message; and
determining the corresponding relationship between the specific resource and the web page based on the corresponding relationship between the player and the web page and the corresponding relationship between the specific resource and the player.

38. The computer-readable medium according to claim 22, wherein displaying the prompt includes:
displaying the prompt indicating the specific resource related to the web page on one or more of an address bar, a tab bar, a toolbar, and a sidebar of the browser and an area where the specific resource is located.

39. The computer-readable medium according to claim 22, wherein displaying the prompt includes:
displaying the prompt indicating the specific resource related to the current web page in a window of the web page containing the specific resource;
when at least two web pages containing identified specific resources, displaying a unified prompt indicating the specific resources contained in each of the at least two web pages; and
when at least two specific resources are identified in the web page, displaying a unified prompt indicating the at least two specific resources contained in the web page.

40. The computer-readable medium according to claim 22, wherein
identifying the specific resource includes identifying a type of the specific resource; and
a content of the prompt includes the type of the specific resource.

41. The computer-readable medium according to claim 22, wherein:
identifying the specific resource includes identifying a name of the specific resource; and
a content of the prompt includes the name of the specific resource.

42. The computer-readable medium according to claim 22, wherein:
identifying the specific resource includes identifying a download address of the specific resource; and
a content of the prompt includes the download address of the specific resource.
